(19) United States
(12) Patent Application Publication
(10) Pub. No.: US 2002/0021079 A1
(43) Pub. Date: Feb. 21, 2002

(54) Bi-potential mask type cathode ray tube having getter shielding element

(76) Inventors: Yong-shik Hwang, Uiwang-city (KR); Tae-Sik Oh, Suwon-city (KR)

Correspondence Address: STAAS & HALSEY LLP, 700 11TH STREET, NW, SUITE 500, WASHINGTON, DC, 20001, US

(21) Appl. No.: 09/878,166

(22) Filed: Jun. 12, 2001

(30) Foreign Application Priority Data
Jun. 13, 2000 (KR) 2000-32521
Sep. 5, 2000 (KR) 2000-52519

(51) Int. Cl. H01J 31/00; H01J 29/94

(52) U.S. Cl. 313/481; 313/479

(57) ABSTRACT

A bi-potential mask type cathode ray tube that includes a bulb having a face panel, a funnel and a neck portion, a phosphor screen on an inner surface of a screen portion in the face panel and supplied with a screen voltage, a shadow mask mounted in a skirt portion of the face panel by a mask frame opposite the phosphor screen and supplied with a mask voltage, an electron gun to emit electron beams toward the phosphor screen, an inner shield fixed to a rear of the mask frame to shield a path of the electron beams from an outer magnetic field, a getter mounted at one side of the electron gun to emit a getter material, and a getter shield to prevent conduction between the phosphor screen and the shadow mask due to evaporation of the getter filler on the inner surface of the skirt portion.

### CROSS-REFERENCE TO RELATED APPLICATIONS

This application claims the benefit of Korean patent Application Nos. 2000-32521 and 2000-52519, filed on Jun. 13, 2000 and Sep. 5, 2000, in the Korean Industrial Property Office, the disclosures of which are incorporated herein by reference.

### BACKGROUND OF THE INVENTION

1. Field of the Invention

The present invention relates to a bi-potential mask type cathode ray tube which supplies differential potentials to a shadow mask and a phosphor screen, and more particularly, to a bi-potential mask type cathode ray tube, in which disadvantages due to conduction between the shadow mask and the phosphor screen may be resolved.

2. Description of the Related Art

In general, a conventional cathode ray tube is a display for realizing a certain image by light emission from a phosphor screen using electron beams. The electron beams are emitted from an electron gun assembly. As three rays of electron beams are emitted from the electron gun corresponding to red R, green G and blue B phosphor layers, the electron beams form a raster on the phosphor screen by magnetic fields generated by a deflection yoke, while being separated into corresponding R, G and B phosphor layers in the phosphor screen by a shadow mask serving as a color selecting electrode so as to express precise colors.

In the conventional cathode ray tube, the phosphor screen and the shadow mask are electrically connected to each other, and a high voltage is applied to the phosphor screen and the shadow mask using an anode button and an incorporated graphite film, which is coated on an inner surface of a funnel. The high voltage serves to accelerate the electron beams emitted from the electron gun to reach the phosphor screen.

On the other hand, in a conventional bi-potential mask type cathode ray tube, the phosphor screen is insulated from the shadow mask, a voltage that is higher than that of the shadow mask is applied to the phosphor screen, so that an acceleration electric field is formed between the shadow mask and the phosphor screen. Accordingly, beam-passing apertures, which are formed on the shadow mask, serve as a fine electronic lenses to focus and deflect electron beams passing through the beam passing apertures. Therefore, the bi-potential mask type cathode ray tube may both effectively improve the brightness of the screen by focusing the electron beams, and reduce deflection power by lowering an internal voltage (which is equal to a voltage of the shadow mask) of a funnel disposed opposite the deflection yoke.

The conventional bi-potential mask type cathode ray tube has, however, disadvantages in that a structure for insulation between the phosphor screen and the shadow mask is required, and differential potentials are to be stably supplied to the phosphor screen and the shadow mask. Specifically, careful attention is required to prevent a stud pin and the phosphor screen from contacting each other by the evaporation of a conductive barium film on an inner surface of a skirt portion. The conductive barium film is generated in the process of getter flashing to exhaust the inside of a bulb and to remove any residual gas. Since the same mask voltage as that of the shadow mask is maintained in the stud pin, any conduction between the phosphor screen and the stud pin is conduction between the phosphor screen and the shadow mask.

Accordingly, the conventional bi-potential mask type cathode ray tube essentially requires a structure that prevents conduction between the phosphor screen and the shadow mask due to the process of getter flashing.

### SUMMARY OF THE INVENTION

It is an object of the present invention to provide a bi-potential mask type cathode ray tube in which a shadow mask and a phosphor screen do not conduct current between each other by providing insulation from a barium film dispersed in the process of getter flashing.

Additional objects and advantages of the invention will be set forth in part in the description which follows and, in part, will be obvious from the description, or may be learned by practice of the invention.

In order to achieve the above and other objects, a bi-potential mask type cathode ray tube according to an embodiment of the present invention includes a bulb formed by sealing a face panel, a funnel and a neck portion, the face panel having a screen portion and a skirt portion, a phosphor screen formed on an inner surface of the screen portion and supplied with a screen voltage, a shadow mask mounted in the skirt portion by a mask frame opposite the phosphor screen and supplied with a mask voltage, an electron gun provided in the neck portion to emit electron beams toward the phosphor screen, an inner shield fixed to the rear of the mask frame to shield a path of the electron beams from an outer magnetic field, a getter mounted at one side of the electron gun and containing a getter filler to emit a getter material in the process of getter flashing, and means for preventing conduction between the phosphor screen and the shadow mask due to the evaporation of the getter filler on the inner surface of the skirt portion in the face panel.

According to another embodiment of the present invention, the preventing means includes a part, which is not exposed in a dispersion direction of the getter material, in the inner surface of the skirt portion, so that a getter film is only partially evaporated on the skirt portion.

According to a further embodiment of the present invention, the preventing means shields a path of the getter filler toward the skirt portion from the getter so that a getter film is not evaporated on the inner surface of the skirt portion.

### BRIEF DESCRIPTION OF THE DRAWINGS

These and other objects and advantages of the invention, and many of the attendant advantages thereof, will be readily apparent and more readily appreciated from the following description of the preferred embodiments, taken in conjunction with the accompanying drawings wherein:

FIG. 1 is a cross-sectional view of a bi-potential mask type cathode ray tube according to an embodiment of the present invention;

FIG. 2 is a partial expanded view of view A of FIG. 1;

FIG. 3 is a perspective of a getter of FIG. 1;

FIG. 4 is an expanded view of a skirt portion of FIG. 1;

FIG. 5 is an expanded view of a skirt portion according to another embodiment of the present invention;

FIG. 6 is a cross-sectional view of a bi-potential mask type cathode ray tube according to a further embodiment of the present invention;

FIG. 7 is a perspective view of a getter shield of FIG. 6;

FIG. 8 is a perspective view of a getter shield according to a still further embodiment of the present invention;

FIG. 9 is a partial expanded view of FIG. 6;

FIG. 10 is a partial expanded view of FIG. 6 illustrating a getter shield according to a yet further embodiment of the present invention; and

FIG. 11 and FIG. 12 are partial expanded views of FIG. 6 illustrating paths of a getter material in the process of getter flashing.

### DETAILED DESCRIPTION OF THE PREFERRED EMBODIMENTS

Reference will now be made in detail to the present preferred embodiments of the present invention, examples of which are illustrated in the accompanying drawings, wherein like reference numerals refer to the like elements throughout. The embodiments are described below in order to explain the present invention by referring to the figures.

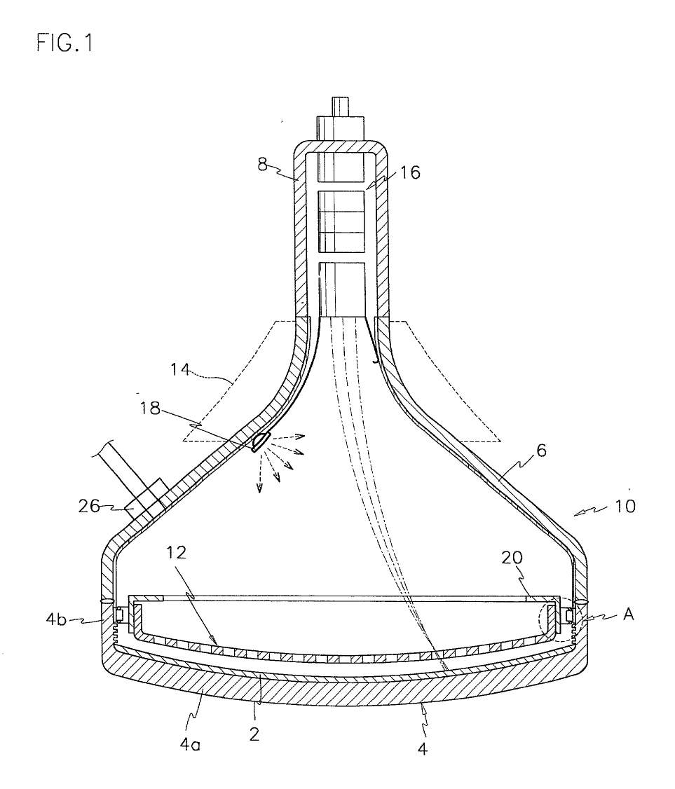

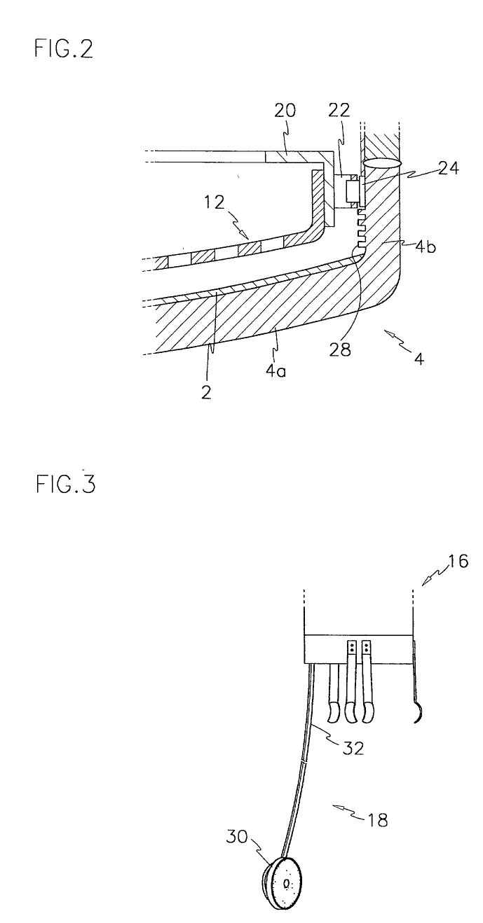

As shown in FIG. 1 and FIG. 2, a bi-potential mask type cathode ray tube according to an embodiment of the present invention includes a vacuum bulb 10. The vacuum bulb 10 is formed by sealing a face panel 4 having a phosphor screen 2 on an inner surface, a funnel 6, and a neck portion 8 together. The face panel 4 has a shadow mask 12 mounted opposite the phosphor screen 2, the funnel 6 has a deflection yoke 14 on an outer periphery, and the neck portion 8 has an electron gun 16 disposed inside the neck portion 8. The electron gun 16 has a getter 18 disposed on one side of the funnel 6 to guarantee a high vacuum state of the bulb 10.

The face panel 4 includes a rectangular screen portion 4a, on which the phosphor screen 2 is formed, and skirt portions 4b extending vertically from four edges of the screen portion 4a toward the electron gun 16 and integral with the funnel 6. The shadow mask 12 is welded on a mask frame 20 at its peripheral part and the mask frame 20 is mounted on stud pins 24 via spring elements 22. In this way, the shadow mask 12 is mounted opposite the phosphor screen 2 at a uniform distance.

The shadow mask 12 and the phosphor screen 2 have respective differential potentials, a screen voltage and a mask voltage, while maintaining an insulation state therebetween. For example, a voltage-dividing element (not shown) is mounted between the shadow mask 12 and the phosphor screen 2 so that a high voltage applied to an anode button 26 is supplied to the shadow mask 12 and the phosphor screen 2 by different potentials, respectively.

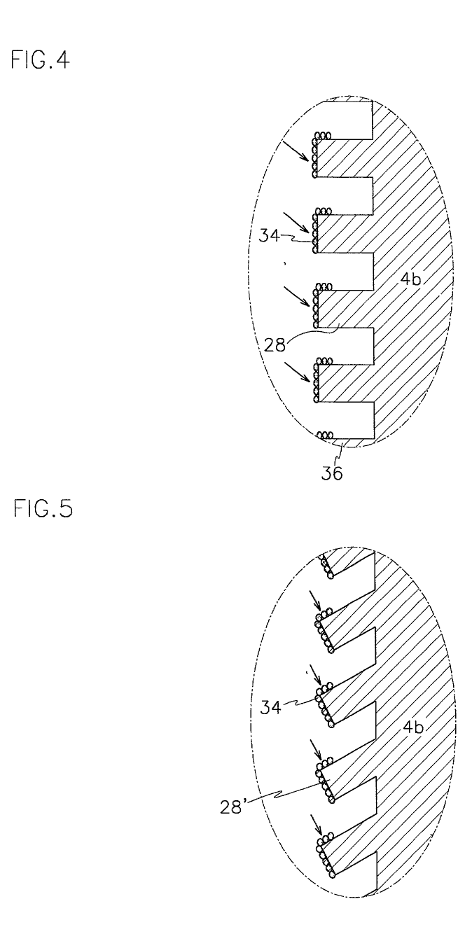

In the bi-potential mask type cathode ray tube which supplies the differential potentials to the shadow mask 12 and the phosphor screen 2 as above, it is important to maintain a definite insulation state between the shadow mask 12 and the phosphor screen 2. A getter film 34 as shown in FIG. 4 is evaporated on the skirt portions 4b of the face panel 4 in the process of getter flashing. An element to prevent the evaporation of the getter material onto an inner surface of the skirt portions 4b is provided on the skirt portions 4b. This element prevents the conduction between the shadow mask 12 and the phosphor screen 2.

That is, as shown in FIG. 3, a getter 18 is attached to one side of the electron gun 16. The getter 18 includes a getter supporting element 30 containing a getter filler and an antenna 32 to connect the getter supporting element 30 to the electron gun 16. If the getter supporting element 30 is heated by high frequency induction heating after a vacuum pump (not shown) exhausts the interior of the bulb 10, the getter material dissipates heat to reach a flash temperature so that the barium is evaporating by the heat and coupled with the residual gas in the bulb 10. This forms the getter film 34 on an inner surface of the bulb 10 as shown in FIG. 4.

Since the skirt portions 4b of the face panel 4, as shown in FIG. 4, has a plurality of protrusions 28 on a surface, the getter film 34 is formed on a partial top part of the protrusions 28 exposed in a dispersion direction of the getter material. However, the getter film 34 is not formed on a lower part of the protrusions 28 not exposed in a dispersion direction of the getter material. Therefore, the getter film 34, which is formed in the process of the getter flashing, is not continuously formed over the whole surfaces of the skirt portions 4b, but is partially formed by the plurality of protrusions 28. This partial formation prevents the conduction between the stud pin 24 and the phosphor screen 2 and, accordingly, the electrical connection between the phosphor screen 2 and the shadow mask 12 is effectively prevented.

As shown in FIG. 4, the protrusions 28 provided on the inner surface of the skirt portions 4b for the partial evaporation of the getter film 34 are, as an example, formed in a plural number on the surface of the skirt portions 4b, wherein the number and the size of the protrusions 28 and the interval between the protrusions 28 may be controlled for more definite partial evaporation of the getter film 34. While not shown, it is understood that the protrusions 28 may have a triangular shape, rounded shape, or have any shape in which a part of the protrusion 28 is not in the dispersion direction to provide partial evaporation of the getter film 34. Further, a properly sized single protrusion 28 could be used so as to not require multiple protrusions 28 as shown.

According to another embodiment of the present invention shown in FIG. 5, a plurality of protrusions 28′ are formed perpendicular to the direction that the getter material is dispersed at a predetermined angle. As shown, it is possible to more definitely prevent the getter film 34 from being successively evaporated since the parts that the getter film 34 is not evaporated on the skirt portion 4b may be expanded by expanding the parts of the getter material which are not exposed in the dispersion direction.

According to the embodiments of the present invention, the insulation state may be maintained between the stud pins 24 and the phosphor screen 2 by the getter film 34 that is partially evaporated on the inner surface of the skirt portions 4b of the face panel 4 using the protrusions 28 and 28′. Thus, the insulation may be effectively maintained between the phosphor screen 2 and the shadow mask 12.

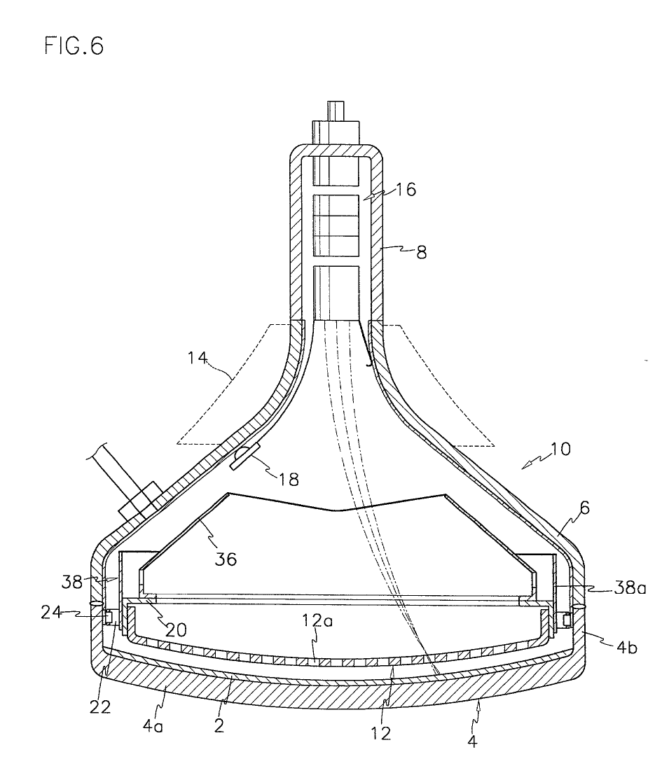

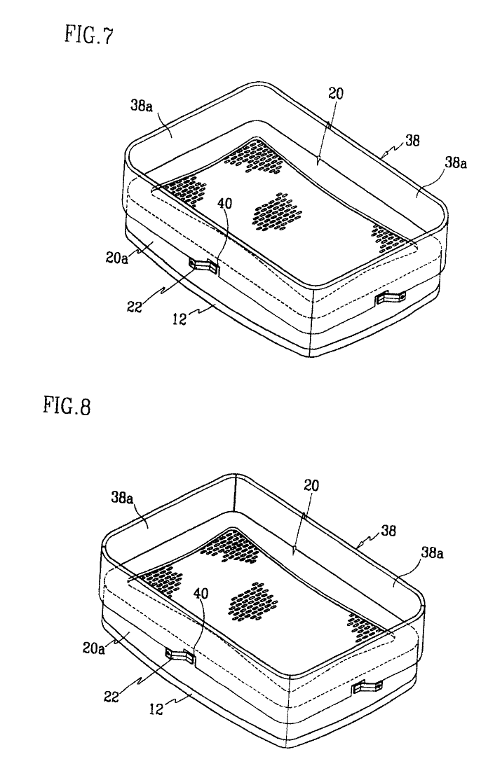

FIG. 6 is a cross-sectional view of a bi-potential mask type cathode ray tube according to a further embodiment of the present invention. An inner shield 36 is fixed to the rear of the mask frame 20 to surround an electron beam path so that the electron beam is shielded from terrestrial magnetic fields. A getter shield 38 is provided to form a shield wall at an outer periphery of the inner shield 36 at a certain height toward the getter 18. A mask assembly provided with the getter shield 38 is shown in FIGS. 7 and 8. While not shown, it is understood that protrusions 28 and 28′ could also be formed on the skirt portions 4b in addition to the getter shield 38 to provide additional insulation.

As shown in FIGS. 7 and 8, the getter shield 38 includes a plurality of shield members 38a having a predetermined height extending toward the getter 18 at the outer periphery of the mask frame 20. In the embodiment shown in FIG. 7, the getter shield 38 includes four shield members 38a corresponding to the shape of the mask frame 20. The shield members 38a are coupled with one another to form a single body. In the embodiment shown in FIG. 8, the getter shield 38 includes four shield members 38a respectively formed to correspond to respective sides of the mask frame 20.

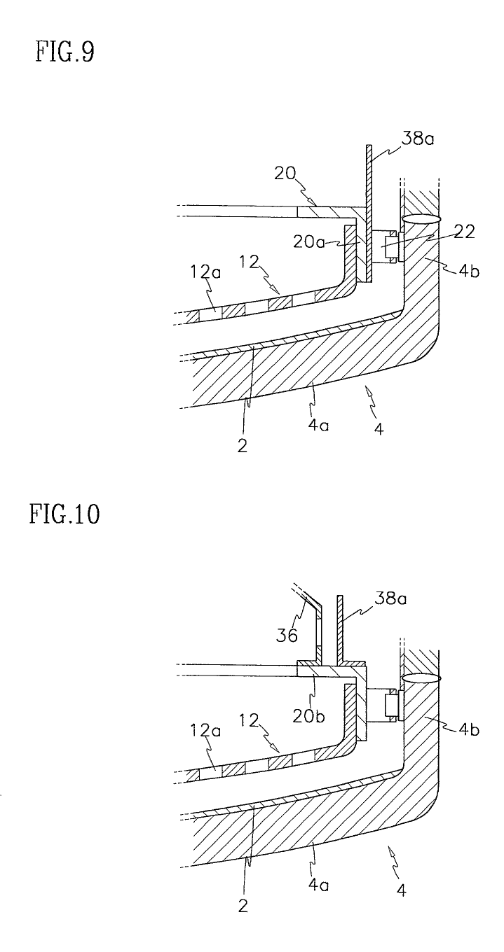

For the embodiments of the present invention shown in FIGS. 7 and 8, the shield members 38a are fixed into the bulb 10 by spot welding on the outer surface of the mask frame 20. Particularly, as shown in FIG. 9, shield members 38a of the getter shield 38 of FIG. 7 is fixed to the outside of a side portion 20a of the mask frame 20 at one end. In an embodiment of the present invention as shown in FIG. 10, one end of the respective shield members 38a is bent at a certain length, the bent part being fixed to the outside of a top portion 20b of the mask frame 20 provided with the inner shield 36 to form a single body with the mask frame 20. However, it is understood that other forms of attachment can be used.

The shield members 38a are fixed to the mask frame 20 by welding. In particular, as shown in FIGS. 7 to 9, the shield members 38a are arranged to overlap the outer surface of the side portion 20a of the mask frame 20, thereby improving the fixed intensity of the shield members 38a. However, since a plurality of spring elements 22 are fixed to the outer surface of the side portion 20a of the mask frame 20, as shown in FIG. 7, a cut part 40 is defined at portions of the shield members 38a adjacent the spring elements 22 to allow the shield members 38a to fit over the spring elements 22. Thus, the shield members 38a can easily be attached to an assembly in which the spring elements 22 are welded to the mask frame 20.

While not shown, it is understood that the getter shield 38 and the mask frame 20 can be integrally formed as a single unit during manufacture as to not require subsequent attachment. Further, it is understood that the protrusions 28 can be used in addition to the getter shield 38, or in addition to certain of the shield members 38a of the shield 38.

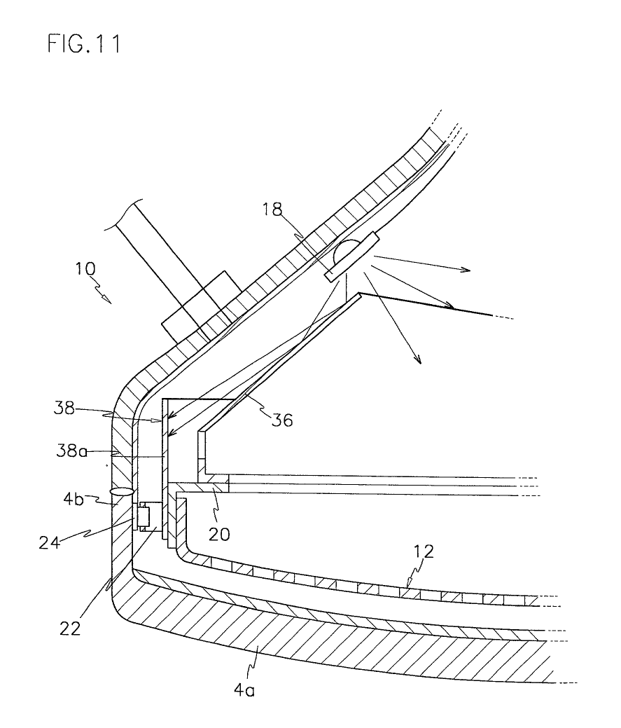

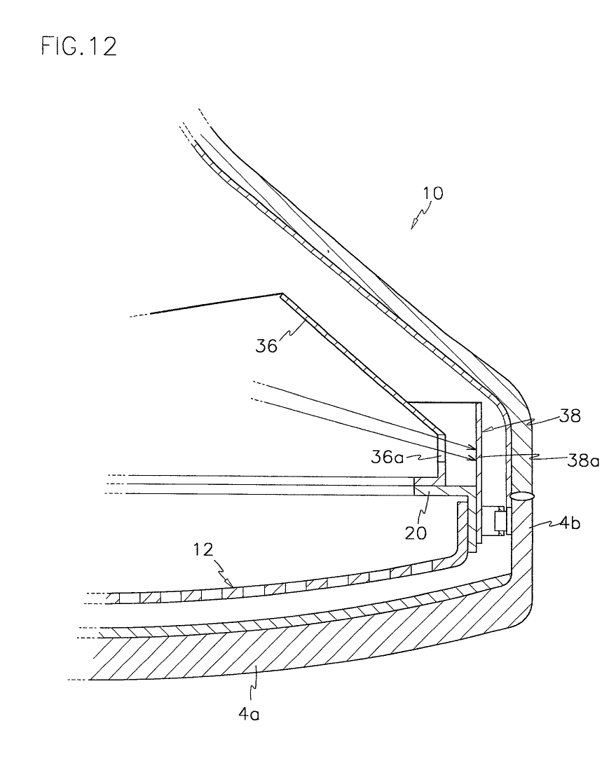

FIGS. 11 and 12 are partial expanded views of FIG. 6 illustrating paths of the getter material in the process of getter flashing. The getter shield 38 shields a path of the getter material so that the getter material is not evaporated on the skirt portions 4b. The getter material emitted from the getter 18 into the bulb 10 partially collides with the outer wall of the inner shield 36 which causes a change in a path of the getter material. However, as shown in FIG. 11, the shield members 38a of the getter shield 38 shields the reflected path of the getter material so that the getter material is evaporated on the inner wall of the shield members 38a, thereby preventing the getter material from being evaporated on the inner surface of the skirt portions 4b.

Moreover, although the getter material dispersed toward the inner part of the inner shield 36 partially leaks out through an aperture 36a formed in the inner shield 36, as shown in FIG. 12, the shield members 38a of the getter shield 38 shields the getter material leaked out from the aperture 36a so that the getter material is evaporated on the inner surface of the shield members 38a.

As described above, the getter shield is disposed in the dispersion path of the getter material so that the getter film is not evaporated on the inner surface of the skirt portions. Thus, the getter shield insulates the phosphor screen from the shadow mask even after getter flashing.

The getter shield may be manufactured using a non-magnetic material that does not generate mutual interference with external magnetic forces if the inner shield sufficiently exerts a terrestrial magnetic field shield effect against the electron beam. For example, the getter shield may be manufactured of stainless steel or ceramic material. As another example, the getter shield is manufactured of a magnetic body to supplement a function of the inner shield so that the electron beam path can be shielded more effectively from the magnetic field. In this case, the getter shield can be manufactured of either a magnetic body having iron as a main component, or a magnetic body having nickel as a main component.

It will be apparent to those skilled in the art that various modifications and variations can be made to the device of the present invention without departing from the spirit and scope of the invention. The present invention covers the modifications and variations of this invention provided they come within the scope of the appended claims and their equivalents.

What is claimed is:

1. A bi-potential mask type cathode ray tube comprising:
a bulb comprising a face panel, a funnel, and a neck portion, the face panel having a screen portion and a skirt portion;
a phosphor screen formed on an inner surface of the screen portion and supplied with a screen voltage;
a shadow mask mounted to the skirt portion by a mask frame opposite said phosphor screen and supplied with a mask voltage;
an electron gun provided in the neck portion to emit electron beams toward said phosphor screen;
an inner shield fixed to a rear of the mask frame to shield a path of the electron beams from an outer magnetic field;
a getter mounted at one side of said electron gun and containing a getter filler to emit a getter material in the process of getter flashing; and
means for preventing conduction between said phosphor screen and said shadow mask due to evaporation of the getter material on an inner surface of the skirt portion of the face panel, said preventing means being attached within said bulb.

2. The bi-potential mask type cathode ray tube of claim 1, wherein said means comprises a part that is not exposed in a dispersion direction of the getter material, the part being disposed in the inner surface of the skirt portion so that a getter film is partially evaporated on the skirt portion.

3. The bi-potential mask type cathode ray tube of claim 2, wherein the inner surface of the skirt portion comprises a concave surface and a convex surface having protrusions, the protrusions being disposed so that the getter film is formed partially on parts of the protrusions which are exposed in the dispersion direction of the getter material.

4. The bi-potential mask type cathode ray tube of claim 3, wherein the protrusions extend vertically from the skirt portion.

5. The bi-potential mask type cathode ray tube of claim 3, wherein the protrusions are disposed perpendicular to the dispersion direction of the getter material and extend toward said phosphor screen at a predetermined angle.

6. The bi-potential mask type cathode ray tube of claim 1, wherein said means is formed of a wall intercepting a path of the getter material between the skirt portion from said getter so that the getter film is not evaporated on the inner surface of the skirt portion.

7. The bi-potential mask type cathode ray tube of claim 6, wherein said means comprises a getter shield that forms a shield wall of a predetermined height extending towards said getter disposed at an outer part of the inner shield.

8. The bi-potential mask type cathode ray tube of claim 7, wherein the getter shield includes four shield members corresponding to a shape of side portions of the mask frame.

9. The bi-potential mask type cathode ray tube of claim 8, wherein one end of the shield members are fixed to an outer surface of the side portion in the mask frame.

10. The bi-potential mask type cathode ray tube of claim 8, wherein the shield members have a bent end that is fixed to an outer surface of a top portion of the mask frame.

11. The bi-potential mask type cathode ray tube of claim 9, wherein the shield members define a cut part extending around a corresponding spring element.

12. The bi-potential mask type cathode ray tube of claim 8, wherein the shield members form a single body.

13. The bi-potential mask type cathode ray tube of claim 8, wherein the e shield members are respectively attached to the mask frame.

14. The bi-potential mask type cathode ray tube of claim 8, wherein the getter shield is made of a magnetic material.

15. The bi-potential mask type cathode ray tube of claim 14, wherein the magnetic material has iron or nickel as a main component.

16. The bi-potential mask type cathode ray tube of claim 8, wherein the getter shield is made of a non-magnetic material.

17. The bi-potential mask type cathode ray tube of claim 16, wherein the nonmagnetic material is a stainless steel or ceramic material.

18. A bi-potential mask type cathode ray tube comprising:
a bulb comprising a face panel;
a phosphor screen on an inner surface of the face panel and supplied with a screen voltage;
a shadow mask mounted on the face panel opposite said phosphor screen and supplied with a mask voltage;
an electron gun mounted in said bulb to emit electron beams toward said phosphor screen;
a getter mounted in said bulb to emit a getter material along a dispersion path; and
a shield attached within said bulb along the dispersion path to prevent the getter material from forming a conductive path between said phosphor screen and said shadow mask.

19. The bi-potential mask type cathode ray tube of claim 18, wherein said shield is attached to said bulb and extends away from said bulb such that the getter material does not form a getter film connecting said shadow mask and said phosphor screen.

20. The bi-potential mask type cathode ray tube of claim 18, wherein said shield is attached around said shadow mask and is made of a magnetic body to provide a magnetic shield against outside magnetic forces.
